(19) United States
(12) Patent Application Publication
(10) Pub. No.: US 2014/0080954 A1
(43) Pub. Date: Mar. 20, 2014

(54) METHODS FOR MAKING THERMALLY CONDUCTVE COMPOSITIONS CONTAINING BORON NITRIDE

(71) Applicants: Chandrashekar Raman, North Royalton, OH (US); Sadhan Jana, Fairlawn, OH (US); Romny Garcia-Buduen, Cuyahoga Falls, OH (US); Kushal Mahinderpal Bahl, Akron, OH (US)

(72) Inventors: Chandrashekar Raman, North Royalton, OH (US); Sadhan Jana, Fairlawn, OH (US); Romny Garcia-Buduen, Cuyahoga Falls, OH (US); Kushal Mahinderpal Bahl, Akron, OH (US)

(21) Appl. No.: 13/828,386

(22) Filed: Mar. 14, 2013

Related U.S. Application Data
(60) Provisional application No. 61/702,779, filed on Sep. 19, 2012.

(51) Int. Cl. C08K 3/40; C08K 3/36; C08K 3/04; C08K 3/26; C08K 3/34; C08K 3/10; C08K 3/38; C08K 3/22

(52) U.S. Cl. CPC C08K 3/40; C08K 3/38; C08K 3/36; C08K 3/22; C08K 3/26; C08K 3/34; C08K 3/10; C08K 3/04
USPC 524/404

(57) ABSTRACT

A thermally conductive composition and a system and method for forming such compositions. The thermally conductive composition comprises a polymer material and a thermally conductive filler, such as boron nitride. In one embodiment, a method of forming a composition having high through-plane conductivity comprises mixing an isotropic boron nitride material, such as boron nitride agglomerates, and a polymer resin material under conditions such that the peak stress during mixing does not exceed 80 kPa.

### CROSS REFERENCE TO RELATED APPLICATIONS

This application claims the benefit of U.S. Provisional Patent Application No. 61/702,779 entitled “Methods For Making Thermally Conductive Compositions Containing Boron Nitride” filed on Sep. 19, 2012 which is hereby incorporated in its entirety by reference.

### FIELD

The present invention provides methods of producing thermally conductive compositions, and thermally conductive compositions formed by such processes. The present invention provides compositions comprising a boron nitride filler material. The thermally conductive compositions and articles formed therefrom can exhibit excellent thermal conductivity in both the in-plane and through plane directions.

### BACKGROUND

Thermal management of various electronic and opto-electronic devices is increasingly gaining attention due to the severe challenges faced in such devices. The trend of shrinking sizes and increased functionality continues in personal hand-held electronic devices. The power density, and hence the density of heat that needs to be dissipated have significantly increased, which poses significant challenges to providing good thermal management in those devices. Similarly, in opto-electronic devices, also known as light emitting diodes (LEDs), the power consumption and lumen output is ever increasing. Thermal management problems are also widely prevalent in other applications such as electronic components in automotives, rechargeable battery systems and power invertors for hybrid vehicles, etc. Insufficient or ineffective thermal management can have a strong and deleterious effect on the performance and long-term reliability of devices.

Currently LED-based bulbs are being used to replace older bulbs and are designed to fit into conventional “Edison” sockets. Fitting LED bulbs into Edison sockets only exacerbates the thermal management challenges since the heat dissipation is limited by natural convection. LED bulbs therefore require well-designed heat sinks to efficiently and adequately dissipate the waste heat. Inefficient thermal management leads to higher operating temperatures of the LEDs, which is indicated by the junction temperature (Tⱼ) of the LED. The lifetime of an LED (defined as time taken to lose 30% light output i.e. reach B70) can possibly decrease from 80,000 hours to 20,000 hours when the junction temperature is increased from 115° C. to 135° C.

Aluminum heat sinks are a natural choice for LED applications based on similarities to heat sinks used for other electronic devices. However the use of aluminum heat sinks for LED bulbs presents several challenges. One challenge is electrically insulating the heat sink from the Edison socket. Any electrical connectivity or leak between a metal heat sink and the socket can be extremely dangerous during installation. Another challenge is providing heat sinks with complex shapes because die-casting heat fin shapes can be difficult and may require costly secondary machining operations. Aluminum heat sinks can also be quite heavy and can add significantly to the weight, and hence cost of transportation, of the bulb. Finally, aluminum heat sinks will need a finish step of painting to smooth surface finish and impart colors desired by the consumers.

Plastic heat sinks are an alternative to aluminum heat sinks Plastics are electrically insulating, more amenable to complex heat sink structures via injection molding, light in weight, and can be colored freely to meet aesthetic or branding requirements. Plastics also offer the possibility of integrating several parts, which can lead to a simpler overall assembly of the bulb. Plastics, however, have very poor thermal conductivity—generally only around 0.2 W/mK—which is nearly two orders of magnitude lower than aluminum alloys typically used in die-casting (around 100 W/mK). Therefore, plastics are generally not insufficient to meet thermal management challenges.

Fillers are often added to plastics to make unique composite materials. For example, reinforcing fillers like glass fibers are added to improve the mechanical properties of plastics. Similarly graphite, carbon black or other carbon forms, including even carbon nanotubes recently are added to plastics to make electrically conductive plastic-based materials. Graphite and metal powders are also used sometimes to enhance thermal conductivity, but this usually leads to increased electrical conductivity as well since these properties are usually concomitant. However, some ceramic materials such as silica, alumina, zinc oxide, magnesium oxide, aluminum nitride, boron nitride (hexagonal or cubic forms), etc. present the opportunity to make thermally conductive yet electrically insulating formulations with plastics since they are good thermal conductors and electrical insulators.

While boron nitride plastic composites have been proposed, boron nitride/plastic composites have several drawbacks. Boron nitride is a relatively expensive material that can cost from 5 to 40 times more than the plastic resins that it is compounded with and as compared to aluminum alloys. From a performance standpoint, the in-plane thermal conductivity of the boron nitride/plastic composite is only around 2-10 W/mK even at high loadings of boron nitride, e.g., above 25-60 wt. % (15-45 vol %). Boron nitride is also very inert and not easily wetted by resins. This leads to imperfect interfaces and large thermal resistances between the filler and matrix, effectively lowering the thermal conductivity of the composite thus leading to higher BN loadings required to achieve the required thermal conductivity. The higher filler loadings drives up the cost of these composites significantly making it less cost competitive in thermal management applications. The poor interfaces between the filler and resin also results in poor physical properties of the composites. It therefore becomes imperative to address the problems of wetting to achieve high thermal conductivity and optimum physical properties.

It is important to note however that even though thermal conductivity of thermally conductive plastics is not as high as aluminum metal, it is sufficient for thermal management applications in LED bulbs, and other convection limited applications. The inherent anisotropy of boron nitride/plastics composites can also be an issue that may limit the applicability of boron nitride/plastic composites.

### SUMMARY

In one aspect, the present invention provides a method of producing thermally conductive plastic compositions. The compositions comprise a polymer matrix and a thermally conductive filler.

In one embodiment, the thermally conductive filler in the composition a boron nitride. In one embodiment, the boron nitride can be chosen from platelet boron nitride, agglomerates of boron nitride, or a combination thereof. In another embodiment, a combination of fillers is employed to provide a composition exhibiting excellent thermal conductivity. In still another embodiment, a composition comprises functionalization additives that provide increased thermal conductivity and allow for the concentration of thermally conductive fillers to be minimized. The methods of processing the compositions provide a method to produce compositions exhibiting high through-plane thermal conductivity.

The present compositions can exhibit good thermal conductivity in the in-plane direction, the through-plane direction or both, even at relatively low loadings of a thermally conductive filler such as boron nitride. This allows for production of thermally conductive compositions at significantly reduced costs. In one embodiment, the compositions have an in-plane thermal conductivity of about 5 W/mK or greater. In one embodiment, the composition has a through-plane thermal conductivity of about 1 W/mK or greater. In one embodiment, the composition has an in-plane thermal conductivity to through-plane conductivity ratio of about 3.5:1 or less.

In another aspect, the present invention provides a thermally conductive composition comprising a polymer material; and a thermally conductive filler dispersed in the polymer material, wherein the composition has an in-plane thermal conductivity of about 2 W/mK or greater, a through-plane thermal conductivity of about 0.9 W/mK or greater, or both.

In one aspect, the present invention provides a process for producing a composition comprising a boron nitride filler material, the process comprising mixing a boron nitride material into a thermoplastic under conditions such that the peak stress during mixing does not exceed 80 kPa. In one embodiment, a composition formed according to such process can have a through-plane thermal conductivity of at least 1.0 W/mK, 1.5 W/mK, etc.

In one aspect, the present invention provides a process for making a thermally conductive composition comprising a boron nitride filler material dispersed in a polymer matrix, the process comprising mixing a boron nitride material with a polymer resin material under conditions such that the peak stress during mixing does not exceed 60 kPa.

In one embodiment, the process produces a composition having a through-plane thermal conductivity of at least 1.0 W/mK. In one embodiment, the process produces a composition having a through-plane thermal conductivity of at least 1.5 W/mK.

In one embodiment, the peak stress during mixing is about 57 kPa or less. In one embodiment, the peak stress during mixing is from about 20 kPa to about 80 kPa.

In one embodiment, the boron nitride material comprises boron nitride agglomerates.

In one embodiment, the process produces a composition having an in-plane thermal conductivity to through-plane thermal conductivity ratio of about 3.5:1 or less.

In one embodiment, the polymer material is a thermoset material, a thermoplastic material, or a combination thereof.

In one embodiment, the boron nitride loading is less than 44 wt %.

In another aspect, the present invention provides a process for making a thermally conductive resin composition comprising a boron nitride filler material, the process comprising mixing a boron nitride material with a polymer resin material under conditions such that the stress in the compounding equipment is about 80 kPa or greater

In one embodiment, the process produces a composition having an in-plane thermal conductivity of at least 2.0 W/mK. In one embodiment, the process produces a composition having an in-plane thermal conductivity of at least 3.5 W/mK. In one embodiment, the process produces a composition having an in-plane thermal conductivity of at least 5.0 W/mK. In one embodiment, the process produces a composition having an in-plane thermal conductivity to through-plane thermal conductivity of about 3.5:1 or less.

In one embodiment, the process produces a composition having an in-plane thermal conductivity to through-plane thermal conductivity of greater than 3.5:1.

In one embodiment, the polymer material is a thermoset material, a thermoplastic material, or a combination thereof.

In still another aspect, the present invention provides a thermally conductive composition comprising a boron nitride filler material, wherein the composition is produced in a compounding process such that the peak stress in the compounding equipment does not exceed 60 kPa, and the composition has a through-plane thermal conductivity of about 1.0 W/mK or greater.

In one embodiment, the composition has a through-plane thermal conductivity of about 1.5 W/mK or greater.

In one embodiment, the composition has an in-plane thermal conductivity to through-plane thermal conductivity ratio of about 3.5:1 or less.

In yet another aspect, the present invention provides a thermally conductive composition comprising a boron nitride filler material, wherein the composition is produced in a compounding process such that the peak stress in the compounding equipment is about 60 kPa or greater, and the composition has an in-plane thermal conductivity of about 2.0 W/mK or greater.

In one embodiment, the composition has an in-plane thermal conductivity of about 3.5 W/mK or greater. In one embodiment, the composition has an in-plane thermal conductivity of about 5.0 W/mK or greater.

In one embodiment, the boron nitride content is 44 wt % or less.

In a further aspect, the present invention provides a process for making a thermoplastic resin composition comprising a boron nitride filler material, the process comprising mixing a boron nitride material into under conditions such that the peak stress during greater than about 80 kPa. In one embodiment, a composition formed according to such process can have an in-plane thermal conductivity of at least 2.0 W/mK, 3.5 W/mK, 5.0 W/mK, etc.

### DETAILED DESCRIPTION

### Thermally Conductive Compositions

A thermally conductive composition comprises a polymer matrix and a thermally conductive filler. In one embodiment, the thermally conductive composition comprises a polymer matrix and a boron nitride material. In another embodiment, the composition comprises multiple thermally conductive fillers. In yet another embodiment, functionalization additives are used along with the thermally conductive fillers.

Polymer Matrix

The polymer matrix material can include any polymer or resin material as desired for a particular purpose or intended application. In one embodiment, the polymer/resin material can be a thermoplastic material. In another embodiment, the polymer/resin material can be a thermoset material. Examples of suitable polymer materials include, but are not limited to, polycarbonate; acrylonitrile butadiene styrene (ABS) (C₈H₈C₄H₆C₃H₃N); polycarbonate/acrylonitrile butadiene styrene alloys (PC-ABS); polybutylene terephthalate (PBT); polyethylene therephthalate (PET); polyphenylene oxide (PPO); polyphenylene sulfide (PPS); polyphenylene ether; modified polyphenylene ether containing polystyrene; liquid crystal polymers; polystyrene; styrene-acrylonitrile copolymer; rubber-reinforced polystyrene; poly ether ketone (PEEK); acrylic resins such as polymers and copolymers of alkyl esters of acrylic and methacrylic acid styrene-methyl methacrylate copolymer; styrene-methyl methacrylate-butadiene copolymer; polymethyl methacrylate; methyl methacrylate-styrene copolymer; polyvinyl acetate; polysulfone; polyether sulfone; polyether imide; polyarylate; polyamideimide; polyvinyl chloride; vinyl chloride-ethylene copolymer; vinyl chloride-vinyl acetate copolymer; polyimides, polyamides; polyolefins such as polyethylene; ultra-high molecular weight polyethylene; high density polyethylene; linear low density polyethylene; polyethylene napthalate; polyethylene terephthalate; polypropylene; chlorinated polyethylene; ethylene acrylic acid copolymers; polyamides, for example, nylon 6, nylon 6,6, and the like; phenylene oxide resins; phenylene sulfide resins; polyoxymethylenes; polyesters; polyvinyl chloride; vinylidene chloride/vinyl chloride resins; and vinyl aromatic resins such as polystyrene; poly(vinylnaphthalene); poly(vinyltoluene); polyimides; polyaryletheretherketone; polyphthalamide; polyetheretherketones; polyaryletherketone, and combinations of two or more thereof.

The choice of polymer matrix material may depend on the particular requirements of the application for which the thermally-conductive plastic is to be used. For example, properties such as impact resistance, tensile strength, operating temperature, heat distortion temperature, barrier characteristics, and the like are all affected by the choice of polymer matrix material.

In some embodiments, the polymer matrix material can include one or more polyamide thermoplastic polymer matrices. A polyamide polymer is a polymer containing an amide bond (—NHCO—) in the main chain and capable of being heat-melted at temperatures less than about 300 degrees Celsius. Specific examples of suitable polyamide resins include, but are not limited to, polycaproamide (nylon 6), polytetramethylene adipamide (nylon 46), polyhexamethylene adipamide (nylon 66), polyhexamethylene sebacamide (nylon 610), polyhexamethylene dodecamide (nylon 612), polyundecamethylene adipamide (nylon 116), polyundecanamide (nylon 11), polydodecanamide (nylon 12), polytrimethylhexamethylene terephthalamide (nylon TMHT), polyhexamethylene isophthalamide (nylon 61), polyhexamethylene terephthal/isophthalamide (nylon 6T/61), polynonamethylene terephthalamide (nylon 9T), polybis(4-aminocyclohexyl)methane dodecamide (nylon PACM12), polybis(3-methyl-4-aminocyclohexyl)methane dodecamide (nylon dimethyl PACM12), polymethaxylylene adipamide (nylon MXD6), polyundecamethylene terephthalamide (nylon 11T), polyundecamethylene hexahydroterephthalamide (nylon 11T(H)) and their copolymerized polyamides and mixed polyamides. Among these, nylon 6, nylon 46, nylon 66, nylon 11, nylon 12, nylon 9T, nylon MXD6, and their copolymerized polyamides and mixed polyamides are exemplary in terms of availability, handleability and the like.

It will be appreciated that the base polymer resins can be modified or provided with other fillers or additives, other than the thermally conductive fillers or silane additives, to modify other properties such as impact resistance, UV stability, fire retardancy, etc.

While aspects and embodiments of the present invention are discussed with respect to applications for producing thermoplastic materials, it will be appreciated that the processing methods, thermally conductive fillers, and silane additives discussed and described herein can easily be translated to applications employing thermoset resins including, but not limited to, silicones, epoxies, acrylics, etc.

Thermally Conductive Fillers

The thermally conductive plastic compositions comprise a thermally conductive filler. It will be appreciated that the compositions can comprise a plurality of thermally conductive fillers. In one embodiment, the thermally conductive filler can be chosen as desired for a particular purpose or application. In one embodiment, the thermally conductive filler is chosen from boron nitride, silica, glass fibers, zinc oxide, magnesia, titania, yttrium oxide, hafnium oxide, calcium carbonate, talc, mica, wollastonite, alumina, aluminum nitride, graphite, metallic powders, e.g., aluminum, copper, bronze, brass, etc., fibers or whiskers of carbon, graphite, silicon carbide, silicon nitride, alumina, aluminum nitride, zinc oxide, nano-scale fibers such as carbon nanotubes, graphene, boron nitride nanotubes, boron nitride nanosheets, zinc oxide nanotubes, etc., or a combination of two or more thereof. In one embodiment, the thermally conductive filler has a low electrical conductivity or is electrically insulating.

In one embodiment, the thermally conductive plastic composition comprises boron nitride. Examples of suitable boron nitride materials include boron nitride particles, boron nitride agglomerates, or a mixture thereof. Boron nitride particles generally exhibit a platelet form. In one embodiment, the boron nitride particles can be platelets having a particle size of 0.3 to about 200 microns and a surface area of from about 0.25 to about 50 m²/gram. In one embodiment, the platelet boron nitride particles have a particle size of about 0.5 to 150 microns; about 1 to about 100 microns, about 10 to 90 microns; about 20 to 75 microns; even about 40 to 60 microns. In another embodiment, the thermally conductive plastic composition comprises boron nitride agglomerates. The agglomerates can have a mean particle size of from about 5 to about 500 microns and a surface area of about 0.25 to about 50 m²/gram. In one embodiment, the platelet boron nitride particles have a particle size of about 10 to 400 microns; about 20 to about 300 microns, about 30 to 200 microns; about 40 to 150 microns; even about 50 to 100 microns. In one embodiment, the boron nitride platelet filler has an aspect ratio (which is defined as the ratio of the largest to smallest dimension of the particle) of at least 20:1; at least 30:1; at least 40:1; even at least 50:1. In another embodiment, the boron nitride agglomerate filler has an aspect ratio of no more than 5:1, 3:1, or even 2:1. Suitable boron nitride materials include platelet boron nitride and boron nitride agglomerates available from Momentive Performance Materials. In one embodiment, the boron nitride comprises a majority of the thermally conductive fillers added in the composition. Here, as elsewhere in the specification and claims, numerical values can be combined to form new or non-disclosed ranges.

The present composition can exhibit excellent through-plane composition without the addition of additional additives such as expanded or carbon fiber graphite as required by U.S. Pat. No. 7,723,419. In one embodiment, the composition can consist essentially of boron nitride fillers. In another embodiment, the composition is substantially free of expanded graphite or other carbon-based fillers.

The thermally conductive plastic compositions can comprise from about 20 to about 80 wt. % of the polymer matrix; from about 30 to about 70 wt. % of the polymer matrix; from about 35 to about 65 wt. % of the polymer matrix; even from about from about 42 to about 58 wt. % of the polymer matrix, and from about 20 to about 80 wt. % of thermally conductive filler; from about 25 to about 65 wt. % of thermally conductive filler; from about 30 to about 58 wt. % of thermally conductive filler; even from about 35 to about 55 wt. % of thermally conductive filler. In one embodiment, the total concentration of thermally conductive filler material is about 60 wt. % or less; about 55 wt. % or less; even about 50 wt. % or less. The volume of polymer matrix in the composition by percent volume (v/v) can range from 20% to about 90%; from 30% to about 80%; from 40% to about 70%; even from 35% to about 65%, and the volume of the thermally conductive filler can range from 10% to about 80%; from 15% to about 65%; from 20% to about 50%; even from 25% to about 45%.

The through-plane thermal conductivity is measured at the center of the tab portion of an ASTM standard dog-bone away from the molding gate using the laser flash method (ASTM E1461) utilizing the theoretical specific heat capacity (Cₚ) values based on the composition. The in-plane thermal conductivity is measured by constructing a laminate sample from the same location as the through-plane measurement method where the laminate sample is constructed in such a way that the thermal conductivity in the plane of the dog-bone sample can be measured either in the flow direction or perpendicular to the flow direction. Tensile properties are measured on an Instron UTM and impact strength on a TMI Impact Tester according to ASTM standards D638 and D256, respectively. For lab-scale experiments, the compounding is carried out in a Brabender Plasticorder batch mixer. The compounded sample is compression molded to less than 0.4 mm and the in-plane thermal conductivity is measured using a modified laser flash method using a special sample holder and an in-plane mask (Netzsch Instruments).

The thermally conductive compositions can exhibit excellent thermal conductivity. In one embodiment, the thermally conductive compositions have an in-plane thermal conductivity of about 2 W/mK or greater; about 3.5 W/mK or greater; about 5 W/mK or greater; even about 10 W/mK or greater. In one embodiment, the thermally conductive compositions comprise boron nitride agglomerates and have a through-plane thermal conductivity of about 0.8 W/mK or greater; about 0.9 W/mK or greater; about 1.0 W/mK or greater; 1.3 W/mK or greater; even about 1.5 W/mK or greater. In one embodiment, the thermally conductive compositions have an in-plane thermal conductivity to through-plane thermal conductivity of about 3.5:1 or lower; about 3.25:1 or lower; about 3:1 or lower; even about 2.5:1 or lower.

The density of the composition can be adjusted as desire for a particular purpose or intended use. In one embodiment, the composition has a density of about 1.8 g/cm³ or less.

### Methods of Forming Thermally Conductive Compositions

The thermally conductive compositions can be formed by mixing the polymer resin material with the thermally conductive filler material. Mixing can be accomplished by any type of mixing equipment or device suitable for mixing resin materials. Examples of suitable mixing equipment includes, but is not limited to Brabender mixers, Banbury mixers, a roll, a kneader, a co-kneader, a single screw extruder, a twin screw extruder, etc.

In one embodiment, the invention provides a method for forming a thermally conductive composition comprising a boron nitride additive and having a relatively high through-plane thermal conductivity. As previously described, high through-plane thermal conductivity compositions can be provided with the use of boron nitride agglomerates. In one embodiment the process of forming a thermally conductive composition comprises mixing a resin material and a boron nitride material under conditions such that the peak stress during mixing is kept relatively low. In one embodiment, the peak stress during mixing does not exceed 80 kPa. In one embodiment, the peak stress during mixing is about 60 kPa or less, about 50 kPa or less, even about 45 kPa or less. In one embodiment, the peak stress during mixing is from about 20 kPa to about 80 kPa; 20 kPa to about 75 kPa; 30 kPa to about 60 kPa; even 40 kPa to about 50 kPa. In one embodiment, the peak stress during mixing is from about 20 kPa to about 60 kPa. In one embodiment, the peak stress during mixing is about 57 kPa. Here, as elsewhere in the specification and claims, numerical values can be combined to form new and non-disclosed ranges.

The peak stress can refer to the respective stress experienced during mixing including, but not limited to shear stress, compressive stresses, stresses from elongational flow, etc. In one embodiment, one or more of the stresses experienced during mixing are individually controlled such that the respective stresses do not exceed 80 kPa.

In one embodiment, the peak shear rate (defined as the shear rate seen by less than 5 vol % of the material in the vicinity of the kneading or mixing elements) can be about 200 s⁻¹ or less, 150 s⁻¹ or less; even 100 s⁻¹ or less.

Keeping the shear stress and peak shear rate relatively low has been found to be beneficial for processing compositions comprising boron nitride agglomerates. Operating at a low shear stress has been found to prevent the breakdown of boron nitride agglomerates. In one embodiment, mixing is accomplished under conditions such that the peak shear stress does not exceed 80 kPa, and the resulting composition has a through-plane thermal conductivity of about 1.0 W/mK or greater, 1.5 W/mK or greater, or higher. In one embodiment, mixing is accomplished under conditions such that the peak shear stress does not exceed 80 kPa, and the resulting composition has an in-plane thermal conductivity to through-plane thermal conductivity ratio of about 3.5:1 or less. It can be appreciated that this shear stress threshold applies for any formulation comprising boron nitride agglomerates, including formulations that utilize other fillers or additives.

In contrast, if high in-plane thermal conductivity is desired, or controlling the high through-plane conductivity is not of particular importance, the peak stress, e.g., the shear stress and other stresses can be so adjusted to exceed 80 kPa, 90 kPa, 100 kPa, or even 200 kPa during mixing. At these stress levels, BN agglomerates break down into their component platelets, which leads to high in-plane conductivity (but lower through-plane conductivity) due to the high aspect ratio of the fillers. Thus the process can be tuned to achieve the desired property. The compounders can benefit from the handling and feeding ease of agglomerates, but yet tune the process to produce high in-plane conductivity materials. Again, the shear stress threshold specified above is applicable to any formulation comprising BN agglomerates, including those with other fillers or additives.

### Articles

The thermally plastic compositions and methods of making such compositions can be used to form molded articles that can be used in a variety of applications. The articles can be shaped to various forms as desired for a particular purpose or intended use. The compositions can be formed into molded articles using methods known to those skilled in the art including, but not limited to, injection molding, injection press molding, gas injection molding, etc. The molded articles can be sheets or other shapes as selected for a particular purpose or intended use.

In one embodiment, the articles can form part of a heat sink structure for thermal management in a variety of applications including lighting assemblies, battery systems, sensors, electronic components, portable electronic devices such as smart phones, MP3 players, mobile phones, computers, televisions, etc.

### Examples

While aspects of the present technology have been described with respect to the detailed description and various embodiments, further aspects of the invention can be further understood in view of the following examples. The examples are only for the purpose of further illustrating possible embodiments of the invention and are not intended to limit the invention or the scope of the appended claims.

TABLE 1

| | | | Peak | | | Through- | In- | |
|---|---|---|---|---|---|---|---|---|
| | | | shear | | BN | plane | plane | |
| | | | stress | Mixing | Wt % | TP-TC | IP-TC | Ratio |
| Ex. # | Resin | RPM | (kPa) | element | (Actual) | (W/mK) | (W/mK) | IP:TP |
| Ex. 1 | PC | 100 | 73 | Kneading | 45.3% | 0.92 | 4.1 | 4.5 |
| Ex. 2 | PC | 150 | 100 | Kneading | 45.0% | 0.89 | 3.9 | 4.4 |
| Ex. 3 | PC | 500 | 255 | Kneading | 45.2% | 0.81 | 3.7 | 4.6 |
| Ex. 4 | PC | 100 | 57 | FME | 45.2% | 1.11 | 3.5 | 3.2 |
| Ex. 5 | PC | 500 | 200 | FME | 44.6% | 1.05 | 3.5 | 3.3 |
| Ex. 6 | PA6 | 100 | 85 | Kneading | 45.6% | 0.87 | 4.7 | 5.4 |
| Ex. 7 | PA6 | 500 | 272 | Kneading | 44.5% | 0.87 | 4.6 | 5.3 |
| Ex. 8 | PA6 | 150 | 68 | FME | 43.8% | 1.17 | 4.1 | 3.5 |
| Ex. 9 | PA66 | 100 | 114 | Kneading | 43.6% | 1.02 | 4.26 | 4.2 |
| Ex. 10 | PA66 | 450 | 235 | Kneading | 44.2% | 0.98 | 5.07 | 5.2 |

Table 1 shows thermal conductivity data of an agglomerate BN grade AC6028 compounded with various resins on a 40 mm twin screw extruder (Steer Omega 40) at various rpms with two different types of mixing elements—standard kneading blocks and Fractional Mixing Element (FME). The nominal loading was 45 wt % for all compositions, but actual loading varied slightly as shown in Table 1. All compositions were injection molded at 1 inch/s.

The data in Table 1 shows that the through-plane conductivity is highest when the peak shear rate is less than 80 kPa. The data also shows that the in-plane thermal conductivity, and ratio of in-plane to through-plane conductivity are highest when the shear stress is greater than 80 kPa. While the data suggests that other factors such as the type of the mixing element and/or the resin used can affect the data, Table 1 illustrates that the peak shear stress can be an important factor to controlling thermal conductivity properties of a material.

TABLE 2

| | Mixing | Mixing | Estimate shear | Through-plane TC |
|---|---|---|---|---|
| Loading | speed (rpm) | time (s) | rate (s⁻¹) | (W/mK) |
| 40 wt % | 1200 | 40 | 31 | 1.26 |
| 40 wt % | 3500 | 30 | 92 | 0.94 |
| 50 wt % | 1200 | 40 | 31 | 3.15 |
| 50 wt % | 3500 | 30 | 92 | 1.33 |
| 60 wt % | 1200 | 40 | 31 | 6.46 |
| 60 wt % | 3500 | 30 | 92 | 1.71 |

Table 2 shows through-plane thermal conductivity data of PT350, an agglomerate BN powder grade used earlier, in a silicone resin. The BN filler is mixed into the resin using a Flacktek SpeedMixer DAC 150 FV in a Max 60 cup. The mixing speed and time conditions are shown in Table 2, along with the estimated shear rate (based on the rotation of the Max 60 cup around its axis) for each mixing condition. As shown in Table 2, increasing the shear rate from 31 s⁻¹ to 92 s⁻¹ dramatically reduces the through-plane conductivity of the resulting composite due to agglomerate breakdown. Additional viscosity characterization of these formulations can be carried out to calculate the shear stress from the shear rates.

TABLE 3

| Mixing | Mixing | Estimated | Through-plane |
|---|---|---|---|
| speed (rpm) | time (s) | shear rate (s⁻¹) | TC (W/mK) |
| 2000 | 20 | 52 | 2.80 |
| 2000 | 60 | 52 | 2.08 |
| 2700 | 30 | 71 | 1.91 |
| 3500 | 20 | 92 | 1.86 |
| 3500 | 60 | 92 | 1.88 |

Table 3 shows through-plane thermal conductivity data of PTX60, another BN agglomerate grade, in a silicone resin. The BN filler is mixed into the silicone resin in a Flacktek SpeedMixer DAC 150 FV in a Max 60 cup. Like before, the mixing conditions and the estimated shear rate based on the rotation of the Max 60 cup about its axis is also shown in Table 3. In summary, the shear rate has been found to have a significant effect on the through-plane thermal conductivity that can be achieved. Viscosity measurements can be performed to calculate the shear stress from the shear rate shown in Table 3.

Embodiments of the invention have been described above and, obviously, modifications and alterations will occur to others upon the reading and understanding of this specification. The invention and any claims are intended to include all modifications and alterations insofar as they come within the scope of the claims or the equivalent thereof.

What is claimed is:

1. A process for making a thermally conductive composition comprising a boron nitride filler material dispersed in a polymer matrix, the process comprising mixing a boron nitride material with a polymer resin material under conditions such that the peak stress during mixing does not exceed 80 kPa.

2. The process of claim 1, wherein the process produces a composition having a through-plane thermal conductivity of at least 1.0 W/mK.

3. The process of claim 1, wherein the process produces a composition having a through-plane thermal conductivity of at least 1.5 W/mK.

4. The process of claim 1, wherein the peak stress during mixing is about 57 kPa or less.

5. The process of claim 1, wherein the peak stress during mixing is from about 20 kPa to about 80 kPa.

6. The process of claim 1, wherein the peak stress during mixing is from about 20 kPa to about 60 kPa.

7. The process of claim 1, wherein the boron nitride material comprises boron nitride agglomerates.

8. The process of any claim 1, wherein the process produces a composition having an in-plane thermal conductivity to through-plane thermal conductivity ratio of about 3.5:1 or less.

9. The process of claim 1, wherein the polymer material is a thermoset material, a thermoplastic material, or a combination thereof.

10. The process of claim 1, wherein the polymer material is chosen from polycarbonate; acrylonitrile butadiene styrene (ABS) (C₈H₈C₄H₆C₃H₃N); polycarbonate/acrylonitrile butadiene styrene alloys (PC-ABS); polybutylene terephthalate (PBT); polyethylene therephthalate (PET); polyphenylene oxide (PPO); polyphenylene sulfide (PPS); polyphenylene ether; modified polyphenylene ether containing polystyrene; liquid crystal polymers; polystyrene; styrene-acrylonitrile copolymer; rubber-reinforced polystyrene; poly ether ketone (PEEK); acrylic resins such as polymers and copolymers of alkyl esters of acrylic and methacrylic acid styrene-methyl methacrylate copolymer; styrene-methyl methacrylate-butadiene copolymer; polymethyl methacrylate; methyl methacrylate-styrene copolymer; polyvinyl acetate; polysulfone; polyether sulfone; polyether imide; polyarylate; polyamideimide; polyvinyl chloride; vinyl chloride-ethylene copolymer; vinyl chloride-vinyl acetate copolymer; polyimides, polyamides; polyolefins such as polyethylene; ultra-high molecular weight polyethylene; high density polyethylene; linear low density polyethylene; polyethylene napthalate; polyethylene terephthalate; polypropylene; chlorinated polyethylene; ethylene acrylic acid copolymers; polyamides, for example, nylon 6, nylon 6,6, and the like; phenylene oxide resins; phenylene sulfide resins; polyoxymethylenes; polyesters; polyvinyl chloride; vinylidene chloride/vinyl chloride resins; and vinyl aromatic resins such as polystyrene; poly(vinylnaphthalene); poly(vinyltoluene); polyimides; polyaryletheretherketone; polyphthalamide; polyetheretherketones; polyaryletherketone, and combinations of two or more thereof.

11. The process of claim 1, where the boron nitride loading is less than 44 wt %.

12. The process of claim 1 further comprising mixing in a filler material chosen from silica; glass fibers; zinc oxide; magnesia; titania; yttrium oxide; hafnium oxide; calcium carbonate; talc; mica; wollastonite; alumina; aluminum nitride; graphite; metallic powders of aluminum, copper, bronze, brass, or combinations of two or more thereof; fibers or whiskers of carbon, graphite, silicon carbide, silicon nitride, alumina, aluminum nitride, zinc oxide; nano-scale fillers chosen from carbon nanotubes, graphene, boron nitride nanotubes, boron nitride nanosheets, zinc oxide nanotubes, or a combination of two or more thereof; or a combination of two or more of any of these materials.

13. A process for making a thermally conductive resin composition comprising a boron nitride filler material, the process comprising mixing a boron nitride material with a polymer resin material under conditions such that the peak stress during mixing is about 80 kPa or greater.

14. The process of claim 13, wherein the peak stress during mixing is from about 80 kPa to about 200 kPa.

15. The process of claim 13, wherein the process produces a composition having an in-plane thermal conductivity of at least 2.0 W/mK.

16. The process of claim 13, wherein the process produces a composition having an in-plane thermal conductivity of at least 3.5 W/mK.

17. The process of claim 13, wherein the process produces a composition having an in-plane thermal conductivity of at least 5.0 W/mK.

18. The process of claim 13, wherein the process produces a composition having an in-plane thermal conductivity to through-plane thermal conductivity of about 3.5:1 or less.

19. The process of claim 13, wherein the process produces a composition having an in-plane thermal conductivity to through-plane thermal conductivity of greater than 3.5:1.

20. The process of claim 13, wherein the polymer material is a thermoset material, a thermoplastic material, or a combination thereof.

21. The process of claim 13, wherein the polymer material is chosen from polycarbonate; acrylonitrile butadiene styrene (ABS) (C₈H₈C₄H₆C₃H₃N); polycarbonate/acrylonitrile butadiene styrene alloys (PC-ABS); polybutylene terephthalate (PBT); polyethylene therephthalate (PET); polyphenylene oxide (PPO); polyphenylene sulfide (PPS); polyphenylene ether; modified polyphenylene ether containing polystyrene; liquid crystal polymers; polystyrene; styrene-acrylonitrile copolymer; rubber-reinforced polystyrene; poly ether ketone (PEEK); acrylic resins such as polymers and copolymers of alkyl esters of acrylic and methacrylic acid styrene-methyl methacrylate copolymer; styrene-methyl methacrylate-butadiene copolymer; polymethyl methacrylate; methyl methacrylate-styrene copolymer; polyvinyl acetate; polysulfone; polyether sulfone; polyether imide; polyarylate; polyamideimide; polyvinyl chloride; vinyl chloride-ethylene copolymer; vinyl chloride-vinyl acetate copolymer; polyimides, polyamides; polyolefins such as polyethylene; ultra-high molecular weight polyethylene; high density polyethylene; linear low density polyethylene; polyethylene napthalate; polyethylene terephthalate; polypropylene; chlorinated polyethylene; ethylene acrylic acid copolymers; polyamides, for example, nylon 6, nylon 6,6, and the like; phenylene oxide resins; phenylene sulfide resins; polyoxymethylenes; polyesters; polyvinyl chloride; vinylidene chloride/vinyl chloride resins; and vinyl aromatic resins such as polystyrene; poly(vinylnaphthalene); poly(vinyltoluene); polyimides; polyaryletheretherketone; polyphthalamide; polyetheretherketones; polyaryletherketone, and combinations of two or more thereof.

22. The process of claim 13 further comprising mixing in a filler material chosen from silica; glass fibers; zinc oxide; magnesia; titania; yttrium oxide, hafnium oxide; calcium carbonate; talc; mica; wollastonite; alumina; aluminum nitride; graphite; metallic powders of aluminum, copper, bronze, brass, or combinations of two or more thereof; fibers or whiskers of carbon, graphite, silicon carbide, silicon nitride, alumina, aluminum nitride, zinc oxide; nano-scale fillers chosen from carbon nanotubes, graphene, boron nitride nanotubes, boron nitride nanosheets, zinc oxide nanotubes, or a combination of two or more thereof; or a combination of two or more of any these fillers.

23. A thermally conductive composition comprising a boron nitride filler material, wherein the composition is produced in a compounding process such that the peak stress in the compounding equipment does not exceed 60 kPa, and the composition has a through-plane thermal conductivity of about 1.0 W/mK or greater.

24. The composition of claim 23 having a through-plane thermal conductivity of about 1.5 W/mK or greater.

25. The composition of claim 23 having an in-plane thermal conductivity to through-plane thermal conductivity ratio of about 3.5:1 or less.

26. A thermally conductive composition comprising a boron nitride filler material, wherein the composition is produced in a compounding process such that the peak stress in the compounding equipment is about 60 kPa or greater, and the composition has an in-plane thermal conductivity of about 2.0 W/mK or greater.

27. The composition of claim 26 having an in-plane thermal conductivity of about 3.5 W/mK or greater.

28. The composition of claim 26 having an in-plane thermal conductivity of about 5.0 W/mK or greater.

29. The composition of claim 26 where the boron nitride content is 44 wt % or less.
